(19) United States
(12) Patent Application Publication
(10) Pub. No.: US 2020/0045193 A1
(43) Pub. Date: Feb. 6, 2020

(54) INFORMATION PROCESSING APPARATUS, INFORMATION PROCESSING METHOD, AND NON-TRANSITORY COMPUTER-READABLE MEDIUM THAT EXECUTE A FUNCTION BASED ON SETTING ITEMS RECEIVED ON AN INPUT SCREEN

(71) Applicant: Takuya MORI, Tokyo (JP)

(72) Inventor: Takuya MORI, Tokyo (JP)

(21) Appl. No.: 16/411,990

(22) Filed: May 14, 2019

(30) Foreign Application Priority Data
Jul. 31, 2018 (JP) 2018-144351
Feb. 4, 2019 (JP) 2019-018010

(51) Int. Cl. H04N 1/00

(52) U.S. Cl. CPC H04N 1/00517; H04N 2201/0094; H04N 1/00949; H04N 1/00474

(57) ABSTRACT

An information processing apparatus, method, and computer-readable medium to execute a function based on settings of a plurality of setting items received on an input screen. The information processing apparatus, method, and computer-readable medium receiving an input of information indicating the function, determining a setting flow of the plurality of setting items corresponding to the function having received the input, based on dependent information indicating a dependency relationship of the plurality of setting items, and displaying a setting screen of at least one of the plurality of setting items corresponding to the function in the determined setting flow.

### CROSS-REFERENCE TO RELATED APPLICATIONS

This patent application is based on and claims priority pursuant to 35 U.S.C. § 119(a) to Japanese Patent Application No. 2018-144351, filed on Jul. 31, 2018, and No. 2019-018010, filed on Feb. 4, 2019, in the Japan Patent Office, the entire contents of each of which are incorporated herein by reference.

### BACKGROUND

### Technical Field

The present disclosure relates to an information processing apparatus, an information processing method, and a non-transitory computer-readable medium.

### Description of the Related Art

Conventionally, in a multifunction peripheral, a screen for setting a device for a user to utilize a function is provided. The settings are often categorized, such as network settings, file transmission settings, destination settings, etc., and it is common for the user to search for setting items to be set from each category.

Further, a technique for setting the setting items of print setting by a wizard is disclosed. By using the wizard, the user can set the necessary setting items in order according to the setting flow of the device setting displayed by the wizard.

### SUMMARY

An information processing apparatus, method, and computer-readable medium to execute a function based on settings of a plurality of setting items received on an input screen. The information processing apparatus, method, and computer-readable medium receiving an input of information indicating the function, determining a setting flow of the plurality of setting items corresponding to the function having received the input, based on dependent information indicating a dependency relationship of the plurality of setting items, and displaying a setting screen of at least one of the plurality of setting items corresponding to the function in the determined setting flow.

### BRIEF DESCRIPTION OF THE SEVERAL VIEWS OF THE DRAWINGS

A more complete appreciation of the disclosure and many of the advantages and features thereof can be readily obtained and understood from the following detailed description with reference to the accompanying drawings, wherein:

FIG. 1 is a diagram illustrating an external configuration of an MFP as an example of an information processing apparatus according to an embodiment;

FIG. 2 is a diagram illustrating an example of a hardware configuration of the MFP;

FIG. 3 is a diagram illustrating an example of a main application of an MFP;

FIG. 4 is a diagram illustrating an example of a configuration of a function block;

FIG. 5 is a diagram illustrating an example of an attribute storage table;

FIG. 6 is a diagram illustrating an example of a sequence of a new registration process to the attribute storage table when a new installation or update of the application is performed in the MFP;

FIG. 7 is a diagram illustrating an example of a state after the update of the attribute storage table by adding a new item;

FIG. 8 is a diagram illustrating an example of processing after activation of a set value application;

FIG. 9 is a diagram illustrating an example of a function selection screen;

FIG. 10 is a diagram illustrating an example of a configuration of an input screen;

FIG. 11 is a diagram illustrating an example of the sequence of the overall operation in the case of setting the device in the MFP;

FIG. 12 is a flowchart illustrating an example of processing in which a setting value application determines an order by an order determination table;

FIG. 13 is a flowchart illustrating an example of a sorting process;

FIGS. 14A-14F are diagrams illustrating an example of a setting flow of a wizard displayed in the order determined by order determination processing;

FIG. 15 is a diagram illustrating an example of a skip selection screen according to a first modified example.

FIG. 16 is a flowchart illustrating an example of a process in which a setting value application determines an order by the order determination table; and

FIGS. 17A-17C are diagrams illustrating an example of a setting flow of a wizard generated when a “Yes” button is selected on the skip selection screen.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of an information processing apparatus, an information processing method, and a non-transitory recording medium according to the present disclosure will be described in detail with reference to the accompanying drawings. An application example to a Multifunction Peripheral (MFP) is shown as an example of an information processing apparatus, but the present disclosure is not limited to this.

### Embodiment

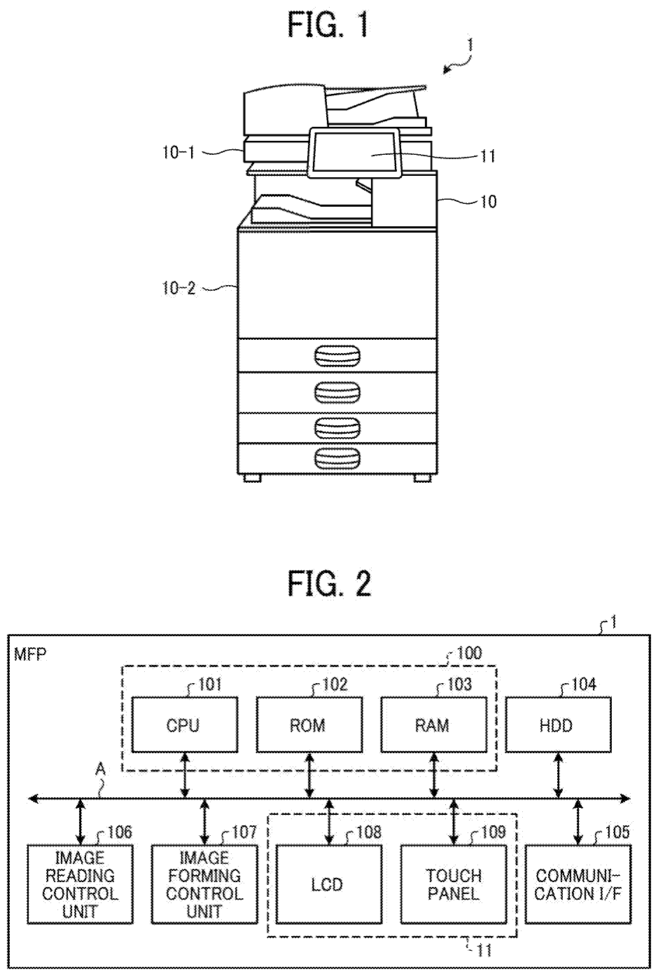

FIG. 1 is a diagram illustrating an external configuration of an MFP as an example of an information processing apparatus according to the embodiment. The information processing apparatus has an image reading unit and an image forming unit, and has a basic function of copy, scan, facsimile (fax), and print.

The MFP 1 shown in FIG. 1 includes an image reading unit 10-1 as a scanner and an image forming unit 10-2 as a plotter on a main body 10.

An operation panel 11 provided in the main body 10 is a user interface that displays a setting screen and receives input of device settings of the main body 10 from the user.

(Hardware Configuration)

The MFP 1 includes a control unit of a computer configuration including a central processing unit (CPU), a read only memory (ROM), a random access memory (RAM), and the like.

FIG. 2 is a diagram illustrating an example of the hardware configuration of the MFP 1. As shown in FIG. 2, the MFP 1 includes a control unit 100 (a CPU 101, a ROM 102, and a RAM 103). Further, the MFP 1 includes a Hard Disk Drive (HDD) 104, a communication I/F 105, an image reading control unit 106, an image forming control unit 107, an LCD 108, and a touch panel 109. The respective units are mutually connected via a system bus A.

The control unit 100 has the CPU 101, the ROM 102, and the RAM 103, and centrally controls the entire MFP 1. The CPU 101 is a central processing unit that executes calculation processing and control processing. The CPU 101 reads various programs stored in the ROM 102, the HDD 104, and the like to the RAM 103 and executes them.

The ROM 102 is a nonvolatile memory that stores a fixed program (for example, Basic Input/Output System (BIOS)). The RAM 103 is a volatile memory used by the CPU 101 as a work area or the like in various processes. The HDD 104 is an auxiliary storage device that stores an Operating System (OS), various kinds of software, various data, and the like.

The communication I/F 105 is an interface for allowing the MFP 1 to connect to a local area network (LAN), the Internet, or the like. Data such as e-mail transmission or folder transmission described later is transmitted to a device on the network through the communication I/F 105. In addition, the communication I/F 105 also has a fax communication unit and the like.

The image reading control unit 106 controls the image reading unit 10-1 according to an instruction from the control unit 100. Specifically, the image reading control unit 106 reads the document image under the control of the image reading unit 10-1. The image forming control unit 107 controls the image forming unit 10-2 according to an instruction from the control unit 100. Specifically, the image forming control unit 107 forms an image on a sheet under the control of the image forming unit 10-2.

The LCD 108 and the touch panel 109 are included in the operation panel 1. The LCD 108 is a display device that displays setting screens such as a function selection screen and an input screen to be described later, for example, according to various kinds of display information output from the CPU 101. Note that the display device is not limited to the LCD but may be an organic EL or the like. The touch panel 109 is a touch sensor that detects the position on the screen of the LCD 108 touched by the user. The touch panel 109 is provided on the screen of the LCD 108, and notifies the CPU 101 of information on the touch position of the user. Note that the input means for performing various setting operations is not limited to the touch panel 109. As one example of the input means, a hardware key for outputting an operation signal to the CPU 101 may be provided, and operations such as various settings may be performed by the hardware key. Further, various setting operations may be performed using an input device such as a mouse.

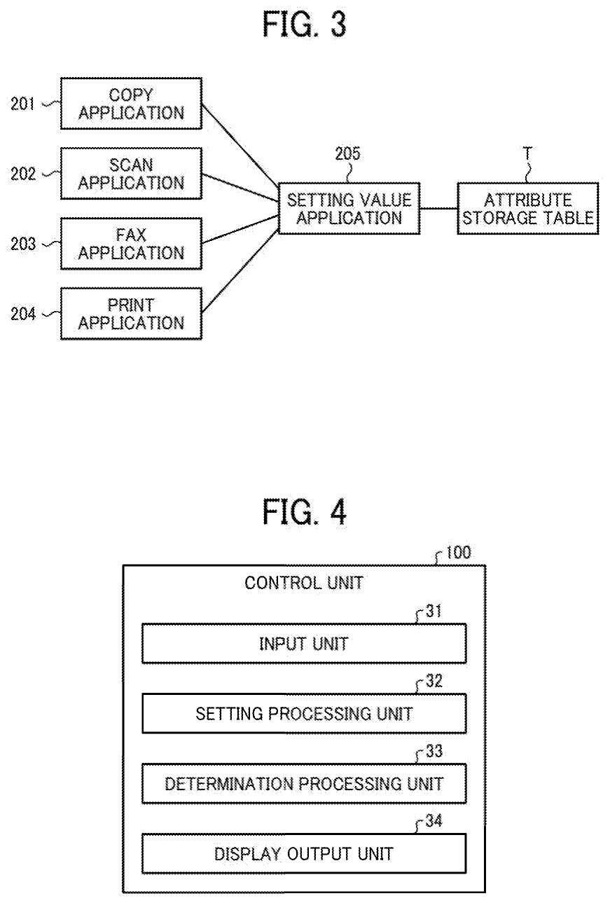

FIG. 3 is a diagram illustrating an example of a main application of an MFP. In the MFP 1, a copy application 201, a scan application 202, a fax application 203, and a print application 204 are installed. Each application functions to perform copy, scan, facsimile, and print processing, respectively. Further, in the MFP 1, a setting value application 205 is installed. The setting value application 205 functions to dynamically generate a setting flow of a wizard for performing device setting of functions desired by the user. Specifically, the setting value application 205 sets, in the attribute storage table T, information (dependent information) indicating a dependency relationship with a function with respect to various setting items possessed by the device. Then, the setting value application 205 dynamically generates a setting flow of the wizard for performing device setting of the specific function designated by the user based on the dependency relationship of each setting item in the attribute storage table T.

FIG. 4 is a diagram illustrating an example of a configuration of a function block. FIG. 4 mainly shows the configuration of function blocks related to device setting. These are implemented in the control unit 100 by the CPU 101 executing a program stored in the ROM 102, the HDD 104, or the like.

The input unit 31 receives input information. For example, the input unit 31 receives a signal input by the user touch-operating the LCD screen from the touch panel 109.

The setting processing unit 32 sets the attribute storage table T in the HDD 104. When there is a new installation or an update, the setting processing unit 32 updates the attribute storage table T based on the setting items corresponding to the setting and the information indicating the dependency relationship. In addition, the setting processing unit 32 displays display information indicating that there is a new setting item for a function requiring device setting by updating the attribute storage table T among the functions of the function selection screen described below.

When the selection of the device setting of the specific function is received in the input unit 31, the determination processing unit 33 sets the setting item and the setting order for setting the received function to the latest setting in the attribute storage table T. For example, the determination processing unit 33 extracts setting items having a dependency relationship with the specific function from various setting items set in the attribute storage table T, and generates an order determination table including setting items restricted by the extraction. Furthermore, the determination processing unit 33 rearranges the setting items of the order determination table in the order of setting according to the information indicating the dependency relationship (priority order) between the setting items. The determination processing unit 33 determines the order of the setting items rearranged in the order determination table as the setting flow of the wizard for setting the device of the function. The determination processing unit 33 requests the display output unit 34 to display the input screen corresponding to each setting item in the order of the determined setting flow.

The display output unit 34 displays the input screen of the wizard on the LCD 108 in the order of the determined setting flow based on the request from the determination processing unit 33.

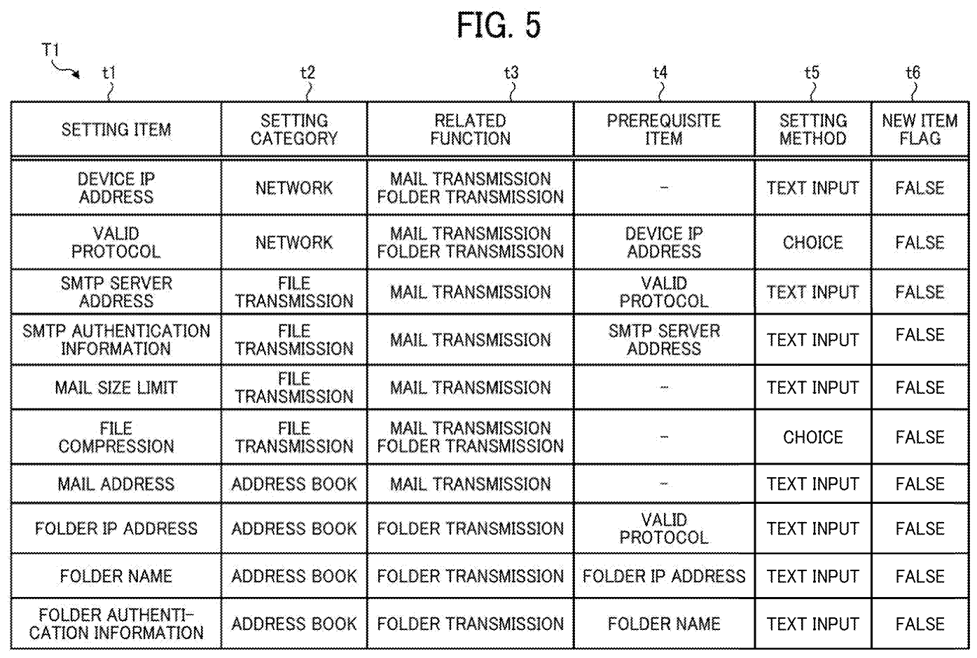

FIG. 5 is a diagram illustrating an example of an attribute storage table T1. The attribute storage table T1 shown in FIG. 5 has a setting item t1, a setting category t2, a related function 13, a prerequisite item t4, a setting method t5, and a new item flag t6. In each item, the relationship between the setting item t1 and the related function t3, and the relationship between the setting item t1 and the prerequisite item t4 mainly corresponds to the information indicating the dependency relationship.

In the setting item t1, the type of setting item (for example, “device IP address”, “valid protocol”, etc.) is set. In the setting category t2, information indicating conventional category division is set. When setting according to the conventional method, since each setting item of setting item t1 is categorized by setting category t2, necessary setting items are searched from the screen or tab showing each category and set.

In the related function t3, information (for example, a function name) indicating a specific function that the user would like to use is set. When a certain specific function is selected by the user, the line (record information) of the setting items (information indicating the type of setting item) of the setting item t1 associated with the same function name as the function selected by the user among the various functions set in the related function 13 is extracted. For example, the user selects a function of “mail transmission”, the lines of setting item t1, “device IP address”, “valid protocol”, “SMTP server address”, “SMTP authentication information”, “mail size limit”, “file compression”, and “mail address” are extracted. Device setting is performed based on the extracted line.

In the prerequisite item t4, another setting item (type of setting item) that must be set before setting each setting item is set. For example, in the setting example on the second line, it means that in order to set the valid protocol, it is necessary to set the device IP address first. With this setting, the setting order of the setting items is guaranteed.

In the setting method t5, a setting method to be performed by the user is set. For example, as an example of the setting method 15, text input, choice, and the like are set. Here, the text input is a setting method of receiving input of text by, for example, providing a text input box on the input screen. A choice is a setting method of receiving input of a selection button by providing a selection button or the like on the input screen.

In the new item flag t6, information for identifying whether each setting item of the setting item t1 is a newly added item is set. In this example, True is set when newly added, and False is set when it is not newly added.

The attribute storage table T1 may be provided with data set in advance in each item t1 to t6 or may be set later by the setting processing unit 32. Further, the attribute storage table T1 is appropriately updated according to the new installation of an application, an update, or the like. Here, the “mail size limit” shown in FIG. 5 indicates a function of stopping the transmission of an e-mail when the size of the e-mail to be transmitted exceeds the set value. For example, when “10 Megabytes” is set as the setting value of “mail size limit”, transmission of e-mail exceeding 10 Megabytes is canceled.

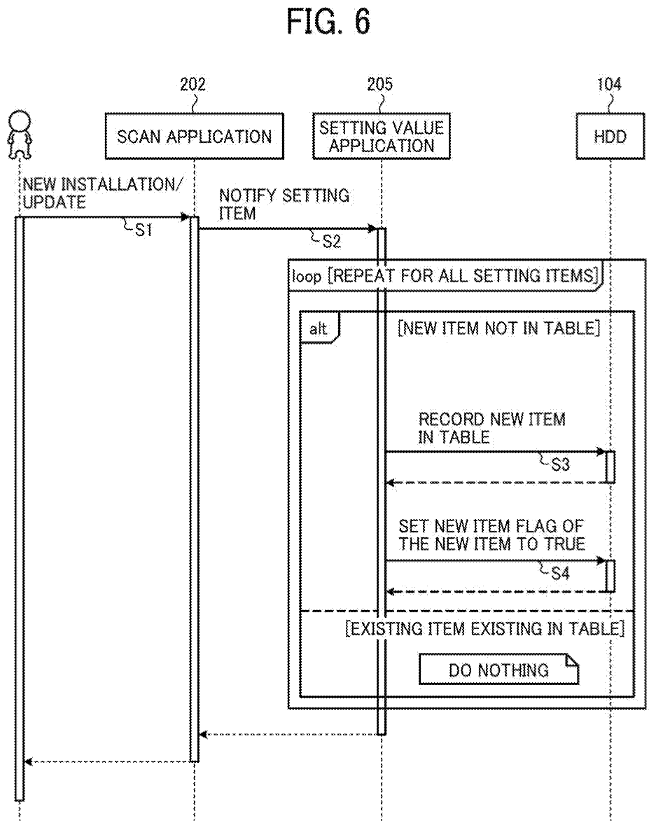

FIG. 6 is a diagram illustrating an example of a sequence of the new registration process to the attribute storage table T1 when a new installation or update of the application is performed in the MFP 1.

First, an application used by the user (here, the scan application 202 is taken as an example) is newly installed or updated (Step S1). Then, the scan application 202 notifies the setting value application 205 of the setting item information to be registered in the attribute storage table T1 (Step S2).

The setting value application 205 checks whether the information of the new item exists in the information of the setting item notified from the scan application 202 based on the latest attribute storage table T1. When there is information of the new item, the setting value application 205 adds (records) the information of the new item to the attribute storage table T1 in the HDD 104 (Step S3).

Further, the setting value application 205 sets the new item flag t6 of the information of the added new item to True (Step S4). Steps S3 and S4 are repeated as many times as the number of new items in the information of the setting items notified from the scan application 202.

Note that the setting value application 205 does not update the attribute storage table T1 when there is no information on the new item in the information of the setting item notified from the scan application 202.

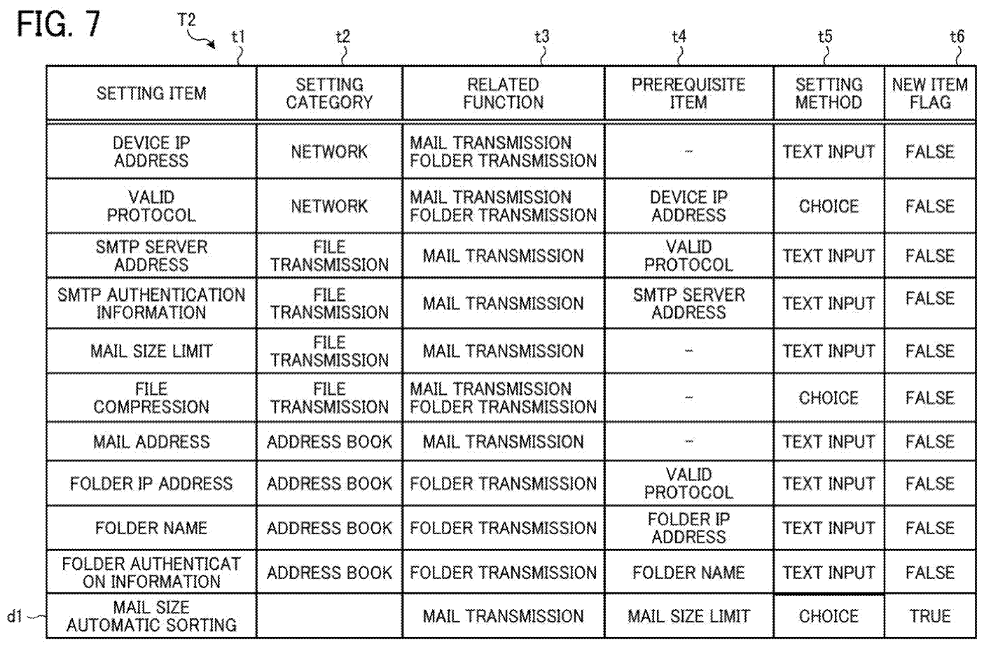

FIG. 7 is a diagram illustrating an example of a state after the update of the attribute storage table T1 by adding a new item. The attribute storage table T2 shown in FIG. 7 is obtained by adding the information dl of the new item to the attribute storage table T1 (see FIG. 5). The information dl of the new item includes “mail size automatic sorting” of the setting item t1, “mail transmission” of the related function t3, “mail size restriction” of the prerequisite item t4, and “choice” of the setting method t5. Further, “TRUE” indicating that it is a new item is set in the new item flag t6. The “mail size auto sorting” indicates whether to change the mode of e-mail and send it or not when the size of the e-mail to be transmitted exceeds the value (the above-described setting value) set in the “mail size limit” item. As an example of changing the mode of the e-mail, the e-mail is divided into a plurality of e-mails so as not to exceed the value set in the “mail size limit” item. Another example is that the MFP 1 stores the attached file of the e-mail in a predetermined storage area and adds identification information such as the file path or file path of the storage destination to the body of the e-mail. In this way, when adding the identification information to the body of the e-mail so as not to transmit the attached file, the user can acquire the attached file based on the identification information added to the e-mail. As a specific example, a link for downloading the attached file is pasted in the e-mail, and the user clicks the link to download the attached file from the storage destination.

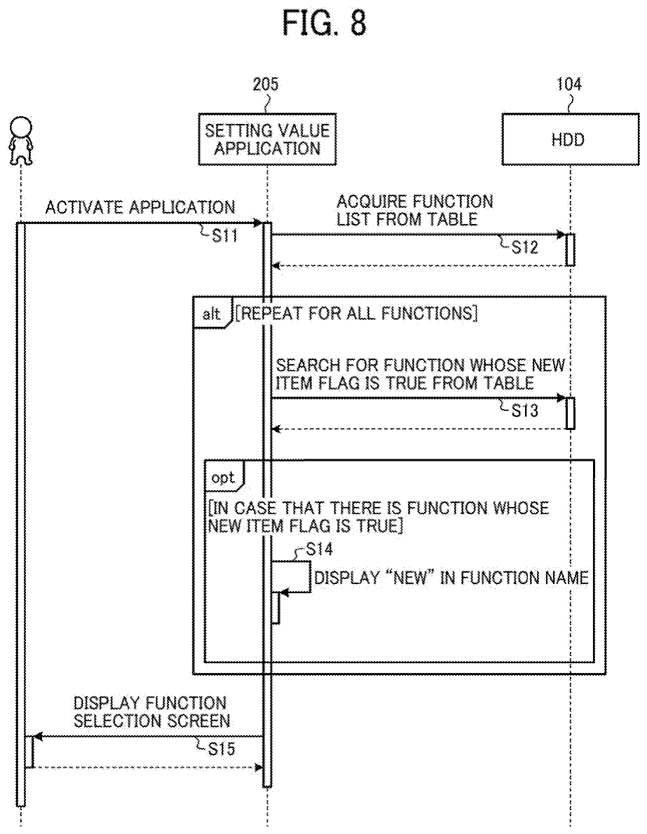

FIG. 8 is a diagram illustrating an example of processing after activation of a setting value application 205. First, when the user activates the setting value application 205 (Step S11), the setting value application 205 acquires a function list (a list of related functions, etc.) included in the attribute storage table T from the HDD 104 (Step S12).

Subsequently, the setting value application 205 searches the attribute storage table T for a line corresponding to the related function based on the acquired function list, and judges whether True is set in the new item flag (Step S13).

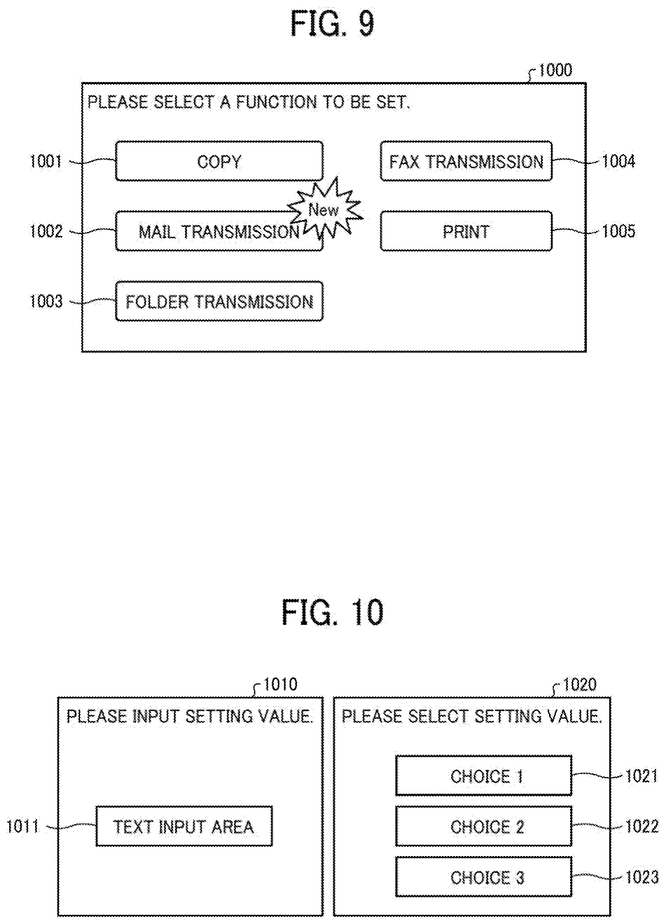

Subsequently, when True is set in the new item flag, the setting value application 205 sets, on the operation button indicating the function name of the target of the function selection screen (see FIG. 9), display information indicating that there is a new setting item (for example, “New”) (Step S14). Specifically, in the case of the attribute storage table T2 (see FIG. 7), only the related function (mail transmission) of the new item information dl is set to True in the new item flag t6. Therefore, the setting value application 205 sets the display information of “New” next to the operation button (see FIG. 9) indicating the function name of “mail transmission” on the function selection screen (see FIG. 9). The setting value application 205 repeats Step S13 and S14 by the number of functions for which the new item flag is set to “True”, and if there are a plurality of new items, the display information of “New” is added to each of the operation buttons of the corresponding related functions.

When the setting of the New display on the function selection screen is completed, the setting value application 205 displays a function selection screen (Step S15).

FIG. 9 is a diagram illustrating an example of a function selection screen. FIG. 9 shows a function selection screen 1000 capable of selecting a basic function and a specific function (related function). A copy button 1001, a fax transmission button 1004, a print button 1005, and the like are operation buttons for setting the basic function. A mail transmission button 1002, a folder transmission button 1003, and the like are operation buttons for setting the specific function. “New” indicated in the mail transmission button 1002 is shown as an example of display information indicating that there is a new setting item.

When the user touches the operation button “New” on the function selection screen, the setting value application 205 generates the setting flow of the wizard. The setting value application 205 displays an input screen corresponding to each setting method (setting of setting method t5) in the order of the setting items. The user completes the device setting by performing various settings in the display order of the input screen. Here, an example of the setting method of the input screen is shown.

FIG. 10 is a diagram illustrating an example of a configuration of an input screen. FIG. 10 shows, as an example, the configuration of an input screen 1010 for inputting text and an input screen 1020 for selecting settings from choices (options). On the input screen 1010, one or more text input areas (text input boxes) are provided according to the number of settings. In this example, one text input area 1011 is provided. A plurality of choice (option) selection buttons are provided on the input screen 1020. In this example, three selection buttons 1021, 1022, and 1023 are provided.

The setting value application 205 has a framework as shown in FIG. 10, and generates an input screen with a framework corresponding to the setting value. The framework is associated with the setting method t5 (see FIG. 7). When the setting method t5 is “text input”, a text input framework is adopted, and when the setting method t5 is “choice”, a choice framework is adopted. After that an input screen is generated.

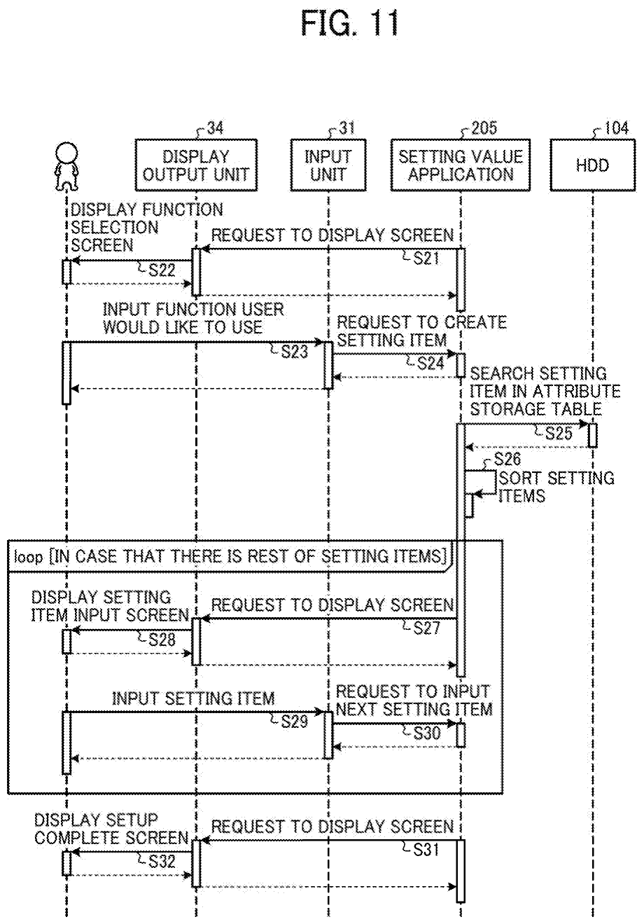

FIG. 11 is a diagram illustrating an example of the sequence of the overall operation in the case of setting the device in the MFP 1. After displaying the function selection screen 1000 (see FIG. 9), the MFP 1 performs device setting of a specific function (New function of the function selection screen 1000) that the user would like to use, as follows. It should be noted that the New display of the function selection screen 1000 is displayed not only once at the first time but also afterwards if the apparatus setting is not performed. For example, it is displayed after activation of the main body, when the user makes a request to display the function selection screen 1000, or the like. Further, after the setting value application 205 sets the device of New function, it is possible not to display the display information of New from the next time on the function selection screen 1000 by changing the new item flag t6 (see FIG. 7) from True to False.

First, the setting value application 205 requests the display output unit 34 to display the screen of the function selection screen (Step S21), and the display output unit 34 displays the function selection screen (for example, the function selection screen 1000 shown in FIG. 9) (Step S22).

When the user touches the operation button of the specific function he or she would like to use from the function selection screen, the input unit 31 receives the input (Step S23).

When the operation button of a specific function is input, the input unit 31 requests the setting value application 205 to create a corresponding setting item (Step S24).

When there is a request to create the setting item, the setting value application 205 searches the attribute storage table T of the HDD 104 and extracts the corresponding setting item (Step S25).

Further, the setting value application 205 generates an order determination table in which the extracted setting items are registered, and rearranges the setting items in the order of setting based on the dependency relationship of each setting item (Step S26). Subsequently, the setting value application 205 requests the display output unit 34 to display the input screen one by one from the beginning in the order of the setting items determined by rearrangement in the order determination table (Step S27).

The display output unit 34 generates an input screen requested to be displayed from the setting value application 205 and displays it on the LCD 108 (Step S28).

The user performs an operation to set the setting item on the input screen displayed on the LCD 108, and the input unit 31 receives the input information (Step S29). Upon receiving the input of the setting item on the input screen, the input unit 31 requests the setting value application 205 to input a next setting item (Step S30). By this request, the operations from step S27 to step S30 are performed on the setting items of the next setting order.

The operation from step S27 to step S30 is repeated until the last setting item of the setting item set in the order determination table is specified. By this operation, the MFP 1 dynamically generates the setting flow of the setting items of the function which the user would like to use based on the latest setting of the attribute storage table T, and provides the dynamically generated setting flow of the wizard.

Upon completion of the setting of the setting items in the last order, the setting value application 205 requests the display output unit 34 to display the setup complete screen (Step S31), and the display output unit 34 displays the setup complete screen (Step S32).

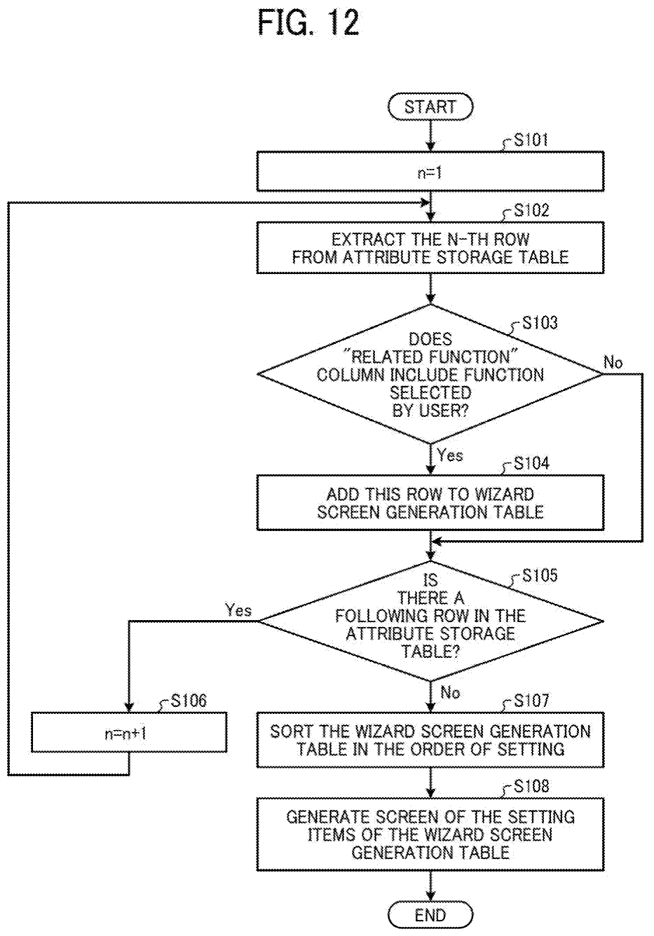

Next, an example of the order determination process performed by the setting value application 205 will be described. FIG. 12 is a flowchart illustrating an example of processing in which a setting value application 205 determines an order by an order determination table. First, the setting value application 205 initializes a parameter n (n is a natural number) (Step S101).

Subsequently, the setting value application 205 extracts the row (line) of the n-th row from the attribute storage table T (Step S102). The row is record information, and at the beginning it extracts the record information of the first row.

Subsequently, the setting value application 205 determines whether the function selected by the user on the function selection screen (the specific function that the user intends to use) is included in the related function t3 column of the extracted row (Step S103).

When the corresponding function is included (Step S103: Yes), the setting value application 205 adds the n-th row to the order determination table (also referred to as a wizard screen generation table) (Step S104).

When the corresponding function is not included (Step S103: No), the setting value application 205 skips step S104 and performs the determination processing of step S105.

Subsequently, the setting value application 205 determines whether there is a next row in the attribute storage table T (Step S105). If there is a next row in the attribute storage table T (Step S105: Yes), the setting value application 205 increments n (Step S106) and repeats the processing from step S102.

If there is no next row in the attribute storage table T (Step S105: No), the setting value application 205 performs sorting processing to sort (rearrange) the order determination table in the setting order of the setting items (Step S107). A specific example of the sorting processing will be described later.

After the sorting processing, the setting value application 205 generates an input screen of setting items in accordance with the setting order after sorting of the order determination table (Step S108).

That is, in this order determination processing, the attribute storage table T is checked row by row to determine whether the column of the related function includes the function selected by the user. Then, the information of the row including the function selected by the user is added to the order determination table. As a result, the order determination table is a table in which only the rows to be generated on the input screen of the wizard are extracted. When all rows of setting items corresponding to the function selected by the user are extracted to the order determination table, the order determination table is sorted based on the dependency relationship of each row, and the setting flow screen of the wizard is generated in the order after sorting.

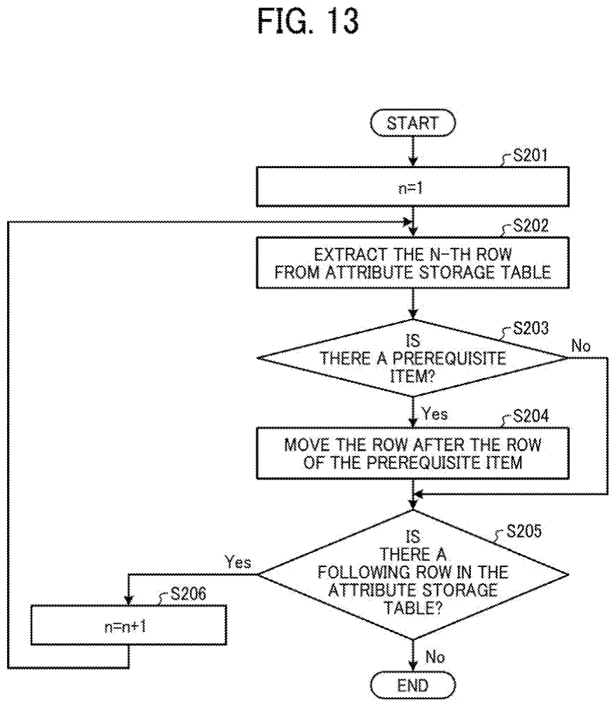

FIG. 13 is a flowchart illustrating an example of a sorting process. First, the setting value application 205 initializes a parameter n (n is a natural number) (Step S201).

Subsequently, the setting value application 205 takes out the n-th row (at first, the first row: record information) from the order determination table (Step S202).

Subsequently, the setting value application 205 determines whether a prerequisite item is included in the prerequisite item t4 column of the extracted row (Step S203).

When the prerequisite item is included (Step S203: Yes), the setting value application 205 moves the n-th row to next to the row including the setting item of the prerequisite item in the setting item t1 column of each row of the ordering table (Step S204). For example, it is assumed that the setting value application 205 extracts the first and second rows from the attribute storage table T shown in FIG. 5 as the order determination table. In this case, the prerequisite item t4 in the second row includes “device IP address”. Further, the “device IP address” is included in the setting item t1 on the first row. Therefore, the setting value application 205 moves the second row next to the first row including the “device IP address” in the setting item t1. When the prerequisite item is not included (Step S203: No), the setting value application 205 skips step S204 and performs the determination process of step S205.

Subsequently, the setting value application 205 determines whether there is a next row in the order determination table (Step S205).

If there is a next row in the order determination table (Step S205: Yes), the setting value application 205 increments n (Step S206), and repeats the process from step S202.

If there is no next row in the order determination table (Step S205: No), the setting value application 205 ends the sorting process.

By the above sorting process, the input screen of the prerequisite items is displayed first in the setting flow of the wizard, and the setting order is secured.

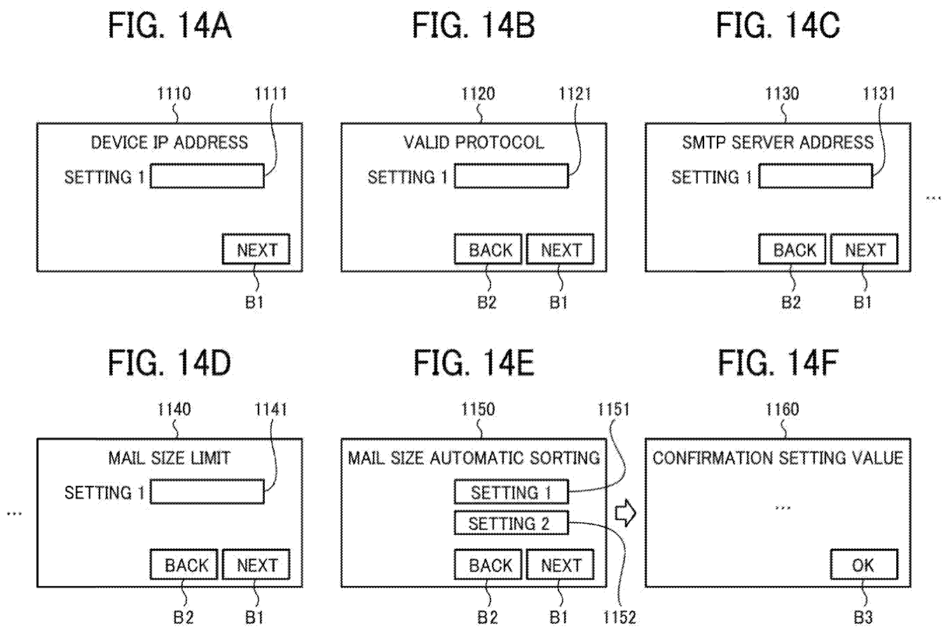

FIG. 14 (14A-14F) is a diagram illustrating an example of a setting flow of a wizard displayed in the order determined by order determination processing. The upper part of each input screen shows the names of setting items set on each input screen. In the case where there is only one setting on each input screen, setting 1 is shown, and when there are a plurality of settings, setting 1, setting 2, and so on are shown.

In an example shown in FIG. 14, first, the input screen 1110 for setting the device IP address is displayed, and the user inputs the setting in the input box 1111 of setting 1. When the user presses a next button B1, the screen moves to the next input screen. In this example, the screen moves to an input screen 1120 of the valid protocol.

Also, on the input screen 1120 of the valid protocol, the user inputs a setting in the input box 1121 of setting 1. When the user presses a back button B2, the screen moves to the previous input screen. When the user presses the next button B1, the screen moves to the next input screen. In this example, the screen moves to an input screen 1130 of the SMTP server address. The next button B1 and the back button B2 have the same function as in the other input screens.

Also, on the input screen 1130 of the SMTP server address, the user inputs settings in the input box 1131 of setting 1, and moves to the next input screen with the next button B1. For example, in FIG. 14, the screen sequentially moves to various input screens (including, for example, an input screen of SMTP authentication information). As described above, setting of various input screens is sequentially performed from the input screen 1130 of the SMTP server address, and the screen is moved to an input screen 1140 of the mail size limit.

When moving to the input screen 1140 of a mail size limit, the user inputs the setting in the input box 1141 of setting 1, and moves to the next input screen with the next button B1.

When moving to an input screen 1150 of the mail size automatic sorting, the user selects one of setting 1 and setting 2 provided as choices, and presses the next button B1. Here, as an example, setting 1 and setting 2 are provided as a selection button 1151 and a selection button 1152, respectively. For example, when the user is made to select whether or not to execute mail size automatic sorting as an option, “YES” is displayed on the selection button 1151 of setting 1 and “NO” is displayed on the selection button 1152 of setting 2.

In this example, the setting of the file compression and the mail address input screen after the input screen 1150 of the mail size automatic sorting is omitted for the sake of brevity. When the setting of the last input screen is completed and the next button B1 is pressed, there is no subsequent input screen, so a setting confirmation screen 1160 is displayed to display the contents set on the input screens. When the OK button B3 is pressed on the setting confirmation screen 1160, the device setting is completed.

The information processing apparatus according to the present embodiment stores the dependency relationship of each setting item, determines the setting flow of the wizard based on the dependency relationship, and displays the wizard screen in the determined setting flow.

As described above, in the present embodiment, the dependency relationship between the function and the setting item, and the priority (dependency relationship) between the setting items are associated with the setting information. Then, an input screen is dynamically generated based on the latest setting information at the time of device setting of the function. Therefore, even if the setting item is added later, the setting information is updated by the information. Accordingly, it is automatically reflected in the setting flow of the wizard when setting the function.

Therefore, when the user would like to use a specific function, the setting flow of the wizard of the corresponding function is automatically generated (constructed), which simplifies the setting. In addition, since the user does not have to search for setting items and the necessary setting input screens are displayed in the correct order without displaying excess settings or without displaying fewer settings than needed, it is possible to prevent the user from setting excess or deficiency.

Here, these effects are described with reference to FIG. 5. Conventionally, the setting items “device IP address” and “valid protocol” are set on the “network” setting screen in order to correspond to the “network” of the setting category t2. The setting items “SMTP server address” and “SMTP authentication information” are set in the “file transmission” setting screen in order to correspond to “file transmission” of the setting category t2. The setting items “folder IP address”, “folder name” and “folder authentication information” are set in the “address book” setting screen in order to correspond to the “address book” of the setting category t2.

However, for example, since the prerequisite item t4 of “SMTP server address” is “valid protocol”, to set “SMTP server address” on the setting screen of“file transmission”, the user has to temporarily switch to the setting screen of “network” and has to set the “valid protocol”. After that, the user has to return to the setting screen of “file transmission” and has to set “SMTP server address”. For this reason, conventionally, it takes some time and effort for the setting.

However, in the present embodiment, these settings can be set by the setting flow of the wizard generated automatically. This saves the user the trouble of switching settings and searching for setting items.

### A First Modified Example

In the embodiment described above, when performing device setting for a new item, an input screen is also displayed for the setting flow of the wizard for the predetermined setting item related to the device setting of the new item. However, the input screen may be skipped. For example, the user is made to select whether or not to skip setting of the existing set items, and when skip is selected, an input screen of only the newly added setting items is displayed. Whether or not to skip the setting of the existing set items can be made to display and select the skip selection screen when the function including the new item is selected on the function selection screen.

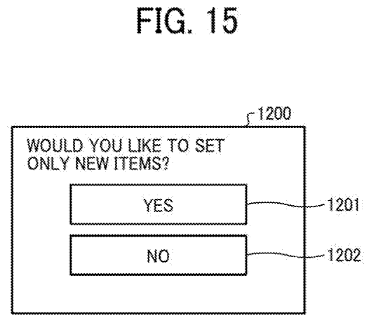

FIG. 15 is a diagram illustrating an example of a skip selection screen according to a first modified example. The skip selection screen 1200 shown in FIG. 15 can be provided with a selection button for selecting whether or not to skip setting of the existing set items. In the example shown in FIG. 15, a “Yes” button 1201 for receiving the selection of “skip” and a “No” button 1202 for receiving the selection of “do not skip” are provided. By selecting the “Yes” button 1201, a wizard screen is generated and displayed only for the new item input screen.

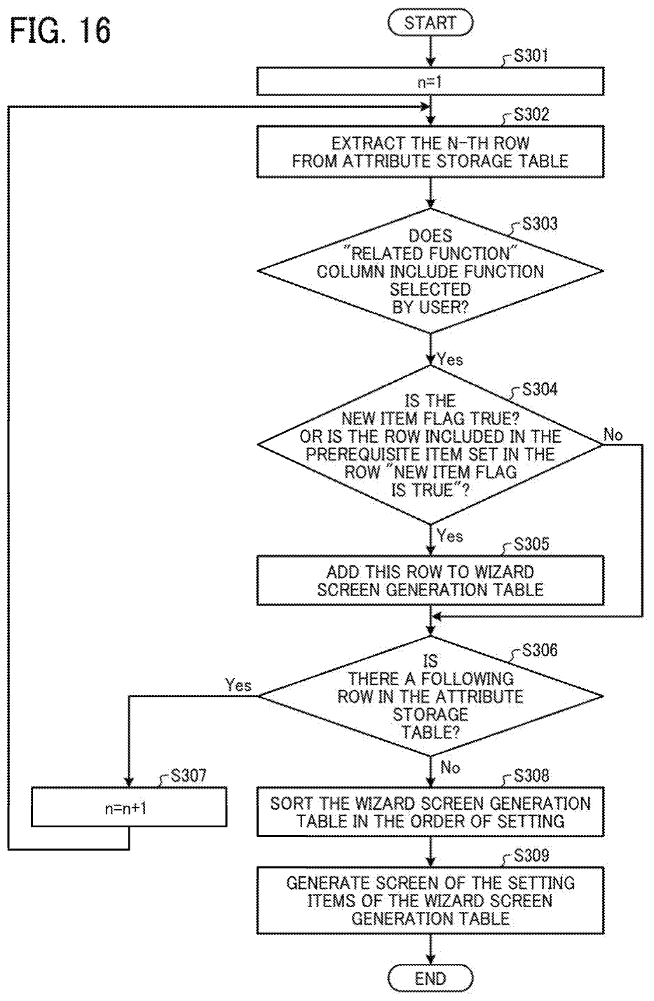

FIG. 16 is a flowchart illustrating an example of a process in which a setting value application 205 determines an order by the order determination table. The flow illustrated in FIG. 16 is a flow obtained by adding processing when the “Yes” button 1201 is selected on the skip selection screen 1200 to the flow (see FIG. 12) shown in the embodiment. Hereinafter, the description of the processing common to the flow illustrated in FIG. 12 is omitted for the sake of brevity, and mainly different processing is described.

The flow illustrated in FIG. 16 includes the determination process (Step S304) between step S103 and step S104 of the flow illustrated in FIG. 12. In FIG. 16, step S303 is the same as step S103 in FIG. 12. That is, the setting value application 205 determines whether the function selected by the user on the function selection screen is included in the related function t3 column of the row extracted from the attribute storage table T. Then, when the function is included (Step S303: Yes), the setting value application 205 performs the determination process (Step S304) according to the first modified example.

Specifically, in the determination process, the setting value application 205 determines whether or not “True” is set in the new item flag t6 column from the rows including the function selected by the user on the function selection screen in the related function t3 column. If “True” is set, or if the row is included in the prerequisite item set in the row “New item flag is True” (Step S304: Yes), the setting value application 205 performs the same processing as step S104 in FIG. 12 in step S305. That is, the setting value application 205 adds the n-th row to the order determination table. As one example, as shown in FIG. 7, “True” is set in the new item flag of the row of new information dl, so the row of new information dl is extracted. Further, in the new information dl row, mail size restriction is set in the prerequisite item, and therefore the mail size restriction row (the fifth row in FIG. 7) is also extracted.

On the other hand, if “True” is not set, and if the row is not included in the prerequisite item set in the row “New item flag is True” (Step S304: No), the setting value application 205 skips step S305 and performs determination processing in step S306. Step S306 is the same as the determination processing of step S105 in FIG. 12.

The other processes (S301, S302, S307, S308, and S309) are performed in the same way as the corresponding steps shown in FIG. 12. The description is omitted here for the sake of brevity.

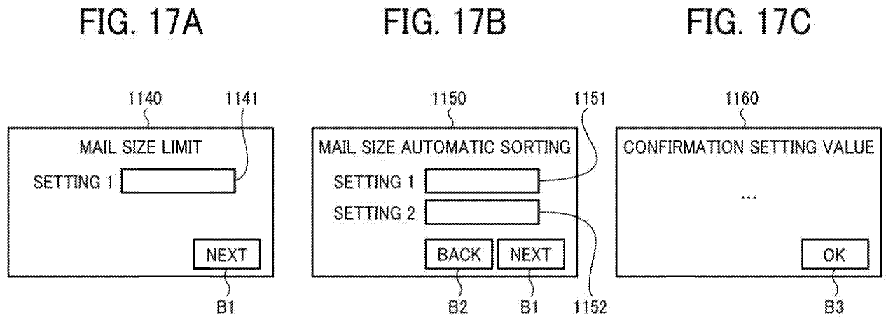

FIG. 17 (17A-17C) is a diagram illustrating an example of a setting flow of a wizard generated when a “Yes” button 1201 is selected on the skip selection screen 1200. Compared with the setting flow when the existing setting is not skipped (refer to FIG. 14), in the setting flow shown in FIG. 17, the input screen 1140 of the mail size limit is displayed immediately by skipping the input screen of the default setting.

As described above, by adding the determination process of step S304, when the new item flag is “False” or the like, the determination in step S304 becomes No, and the addition of the n-th row is excluded from the order determination table. Therefore, the existing setting item is excluded from the generation of the input screen by the “False” or the like, and the existing setting is skipped from the setting flow of the wizard.

It is not always easy to find setting items in the category setting for device setting provided on the screen of the conventional device setting. For example, when the user wishes to use a specific function of scanning a document and sending it by e-mail, it is necessary for the user to search for and set related setting items from the category of network setting, file transmission setting, and destination setting by the user. Since the user by himself/herself sets it, the setting may be excessive or insufficient. Also, if the setting flow of the wizard is provided in advance, the setting is easy. However, the function each user would like to use differs depending on each user. Preliminarily preparing the setting flow of the wizard for all the functions is not feasible because there are items to be added later. Therefore, also in this case, the user himself/herself must finally find out the setting item when setting a function not preparing the setting flow of the wizard. As described above, conventionally, when the user himself/herself would like to utilize a specific function, the user must search and set related setting items from each category.

Accordingly, an object of the present disclosure is to provide an information processing apparatus, an information processing method and a non-transitory recording medium capable of setting without excess or deficiency by saving the labor of searching for setting items by a user when a user wishes to use a specific function.

Although the present embodiment and the modified example illustrate an application example to the MFP as an example of the information processing apparatus, the information processing apparatus is not limited to an MFP. For example, the information processing apparatus may be applied not to a multifunction peripheral but to an image processing apparatus (e.g. image forming apparatus or image reading apparatus) having one function. In addition, the information processing apparatus may be applied to a projector, an electronic blackboard, and the like. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Programs executed by the computer in the present embodiment and the modified example may be recorded and provided on a computer readable recording medium, such as a CD-ROM, a flexible disk (FD), a CD-R, a Digital Versatile Disk (DVD), etc. In addition, the programs of the present embodiment and the modified example may be provided by being incorporated in advance in a ROM or the like.

Also, the program executed by the computer in the present embodiment and the modified example may be stored on a computer connected to a network such as the Internet and provided by downloading via the network. Further, the program executed by the computer in the present embodiment and the modified example may be provided or distributed via a network such as the Internet.

1. An information processing apparatus to execute a function based on settings of a plurality of setting items received on an input screen, the information processing apparatus comprising:
circuitry configured to
receive an input of information indicating the function,
determine a setting flow of the plurality of setting items corresponding to the function having received the input, based on dependent information indicating a dependency relationship of the plurality of setting items, and
display a setting screen of at least one of the plurality of setting items corresponding to the function in the determined setting flow.

2. The information processing apparatus according to claim 1, further comprising:
a memory configured to store the dependent information indicating a dependency relationship of the plurality of setting items.

3. The information processing apparatus according to claim 1,
wherein, in response to receiving the input of information indicating the function, the circuitry determines the setting flow of the plurality of setting items corresponding to the function, based on dependent information indicating the dependency relationship of the plurality of setting items.

4. The information processing apparatus according to claim 3, wherein, after a new setting item has been added to the plurality of setting items corresponding to the function, the circuitry is configured to determine the setting flow of the plurality of setting items corresponding to the function, based on the dependent information indicating the dependency relationship of the plurality of setting items including the new setting item.

5. The information processing apparatus according to claim 4, wherein the circuitry is configured to display information in association with the function, the display information indicating that the new setting item is newly added to the plurality of setting items corresponding to the function.

6. The information processing apparatus according to claim 1, wherein, after receiving the input of information indicating the function, the circuitry is configured to restrict setting items to the plurality of setting items that correspond to the received function.

7. The information processing apparatus according to claim 6, wherein
the dependent information includes information indicating the priority order of the plurality of setting items, and
the circuitry is configured to rearrange the setting flow of the restricted setting items based on the information indicating the priority order.

8. The information processing apparatus according to claim 1, wherein the circuitry is configured to skip displaying of a setting screen associated with an existing item of the setting flow.

9. A method of executing a function based on settings of a plurality of setting items received on an input screen, the method comprising:
receiving an input of information indicating the function;
determining a setting flow of the plurality of setting items corresponding to the function having received the input, based on dependent information indicating a dependency relationship of the plurality of setting items; and
displaying a setting screen of at least one of the plurality of setting items corresponding to the function in the determined setting flow.

10. A non-transitory computer-readable medium storing a program that when executed by a computer that executes a function based on settings of a plurality of setting items received on an input screen, causes the computer to perform a method comprising:
receiving an input of information indicating the function;
determining a setting flow of the plurality of setting items corresponding to the function having received the input, based on dependent information indicating a dependency relationship of the plurality of setting items; and
displaying a setting screen of at least one of the plurality of setting items corresponding to the function in the determined setting flow.
